(19) United States
(12) Patent Application Publication
(10) Pub. No.: US 2014/0253757 A1
(43) Pub. Date: Sep. 11, 2014

(54) APPARATUS FOR MANAGING MEDICINE ADMINISTERING PROCESS, AND CONTROL PROGRAM THEREFOR

(71) Applicants: YUMIKO OKUMA, Tokyo (JP); MAKI SATO, Kanagawa (JP); TOSHIHIDE MURATA, Shizuoka (JP); SHUNICHIRO KAMAMOTO, Shizuoka (JP); SHIOMI MATSUI, Shizuoka (JP); TOMOYUKI TAKE, Shizuoka (JP)

(72) Inventors: YUMIKO OKUMA, Tokyo (JP); MAKI SATO, Kanagawa (JP); TOSHIHIDE MURATA, Shizuoka (JP); SHUNICHIRO KAMAMOTO, Shizuoka (JP); SHIOMI MATSUI, Shizuoka (JP); TOMOYUKI TAKE, Shizuoka (JP)

(73) Assignee: TOSHIBA TEC KABUSHIKI KAISHA, Tokyo (JP)

(21) Appl. No.: 14/194,454

(22) Filed: Feb. 28, 2014

(30) Foreign Application Priority Data
Mar. 5, 2013 (JP) 2013-043550

(51) Int. Cl. H04N 5/232

(52) U.S. Cl. CPC H04N 5/23293
USPC 348/231.5

(57) ABSTRACT

An apparatus for managing a medicine administering process to enable inspection of the medicine administering process, includes a video recording unit that generates video recorded image data by video recording the medicine administering process, and a data addition unit that adds controlling data that enables the recorded video of the medicine administering process to be displayed with display elements that depict transition events of the medicine administering process.

### CROSS-REFERENCE TO RELATED APPLICATION

This application is based upon and claims the benefit of priority from Japanese Patent Application No. 2013-043550, filed Mar. 5, 2013, the entire contents of which are incorporated herein by reference.

### FIELD

Embodiments described herein relate generally to an apparatus for managing medicine combination and preparation, and a control program therefor.

### BACKGROUND

In the related art, in a pharmacy of a hospital, a nurse's room of a ward, or the like, a pharmacist or a nurse carries out a combination and preparation operation (hereinafter, referred to as administering) of medicines which are prescribed based on an instruction such as a prescription, an injection prescription, or the like which is provided by a doctor.

When administering the medicines, first, it is necessary to collect a plurality of medicines which are prescribed based on the instruction, to measure, dissolve, and combine the plurality of collected medicines through an adequate procedure, and the like.

### DESCRIPTION OF THE DRAWINGS

FIG. 1 is a schematic block diagram of a system for managing a medicine administering process.

FIG. 2 is a schematic block diagram of a administering support terminal device.

FIG. 3 is a schematic block diagram of an information processing terminal device for an inspector.

FIG. 4 is a processing flow chart of a administering support terminal device during a medicine administering operation.

FIG. 5 is a diagram illustrating a screen of video recording and displaying a moving image for inspection.

FIG. 6 is a processing flow chart of an information processing terminal device for an inspector while inspecting a medicine administering operation.

### DETAILED DESCRIPTION

In order to administer medicine in a precise manner, before doing so, an inspection for checking whether or not a plurality of collected medicines are to be administered is performed based on labels of medicines and instructions.

In addition, it is necessary to assign an inspector who checks the process carried out by a worker dispensing the medicines to see whether or not measuring, dissolving, combining and the like of the plurality of collected medicines are performed through an adequate procedure. However, the medicine administering operation varies depending on the types of target medicines, and therefore, the work requires skill and a large amount of time for the inspecting.

In general, according to one embodiment, an apparatus for managing a medicine administering process enables inspection of the medicine administering process.

Here, a video recording unit generates video recorded image data by video recording the medicine administering process.

A data addition unit adds controlling data that enables the recorded video of the medicine administering process to be displayed with display elements that depict transition events of the medicine administering process.

Next, a preferable mode of the embodiment will be described with reference to the drawings.

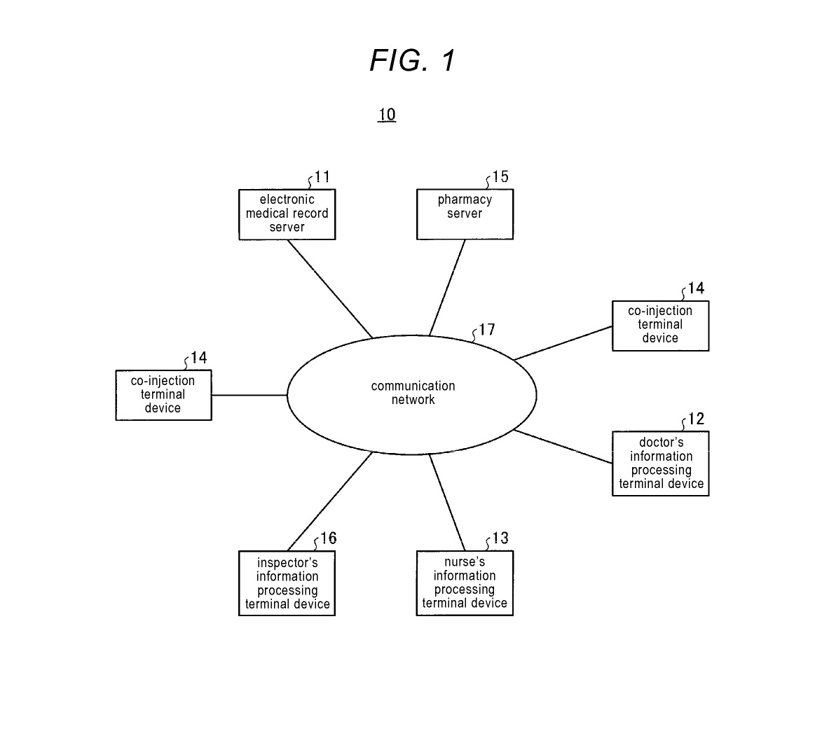

FIG. 1 is a schematic block diagram of a system for managing a medicine administering process.

The system for managing a medicine administering process 10 includes an electronic medical record server 11 that manages and stores electronic medical records; an information processing terminal device 12 for a doctor for creating and entering data for the electronic medical records or the like; an information processing terminal device 13 for a nurse for referring to and confirming the electronic medical record which is managed by the electronic medical record server 11; a plurality of dispensing support terminal devices 14 that support the medicine dispensing such as collecting the medicines based on information of a prescription included in the electronic medical record; a pharmacy server 15 that is disposed in a pharmacy and manages medicine delivery or the like; and an information processing terminal device for an inspector for inspecting a medicine administering operation.

In the above configuration, the electronic medical record server 11, the information processing terminal device 12, the information processing terminal device 13, the administering support terminal device 14, the pharmacy server 15, and the information processing terminal device 16 are connected to a communication network 17.

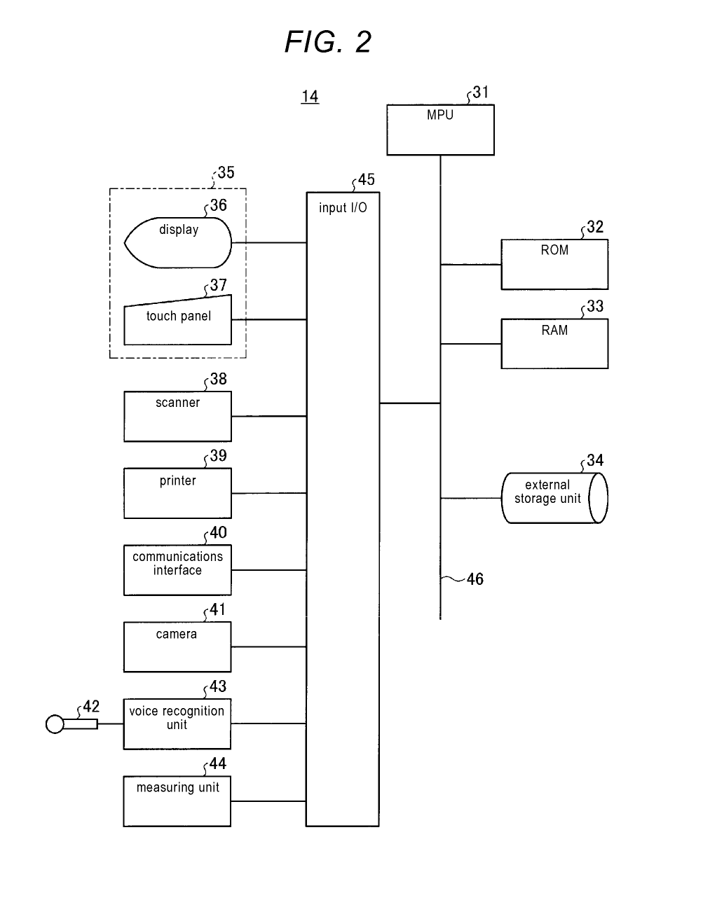

FIG. 2 is a schematic block diagram of the administering support terminal device.

The administering support terminal device 14 includes an MPU 31 that controls the entire administering support terminal device 14; a ROM 32 that stores various data pieces containing a control program in a non-volatile manner; a RAM 33 that functions as a work area and temporarily stores various data pieces; an external storage unit 34 configured as a solid state drive (SSD) and/or a hard disk drive capable of storing a large capacity of data such as a database; a display 36 and a touch panel 37 configuring a touch panel display 35; a scanner 38 configured as an object scanner that scans a barcode or an image of a medicine and specifies the medicine; a printer 39 that prints out various information; a communication interface 40 that performs a communication interface operation; a (video) camera 41 that video records the medicine administering operation as a moving image; a microphone 42 that inputs voice data; a voice recognition unit 43 that recognizes the voice input from the microphone 42; and a measuring unit 44 that measures the weight of medicines during the combination and preparation of the medicines.

Here, the touch panel display 35, the scanner 38, the printer 39, the communication interface 40, the camera 41, the voice recognition unit 43 and the measuring unit 44 are connected to a bus 46 via an input and output I/O 45.

The bus 46 is connected to the MPU 31, the ROM 32, the RAM 33 and the external storage unit 34.

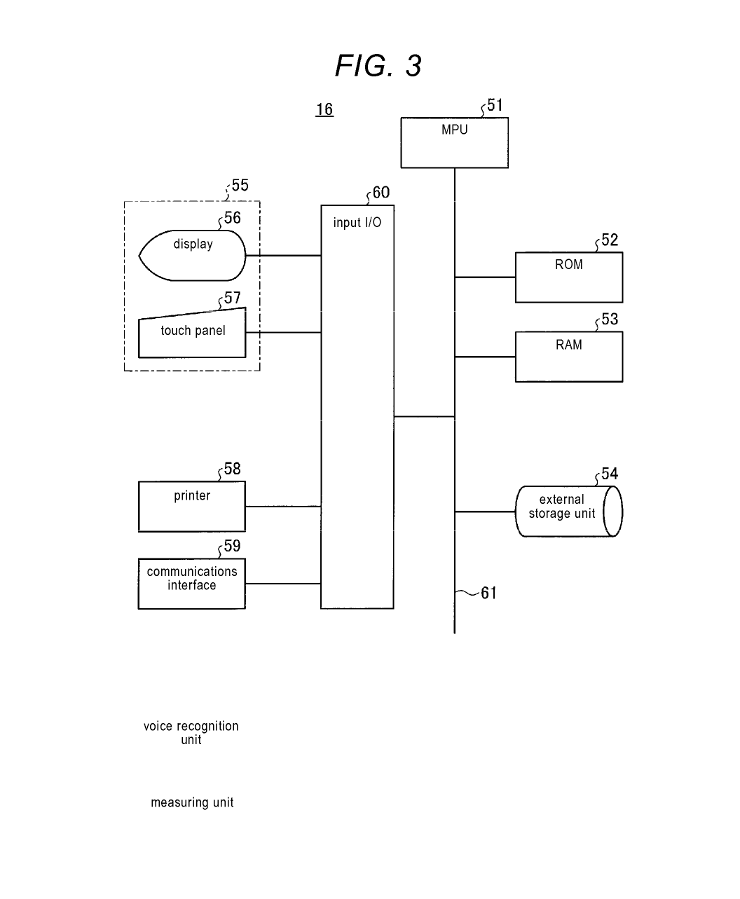

FIG. 3 is a schematic block diagram of an information processing terminal device for an inspector.

The information processing terminal device 16 for an inspector includes an MPU 51 that controls the entire information processing terminal device 16, a ROM 52 that stores various data pieces containing a control program in a non-volatile manner; a RAM 53 that functions as a work area and temporarily stores various data pieces; an external storage unit 54 configured as a solid state drive (SSD) and/or a hard disk drive capable of storing a large capacity of data such as a database; a display 56 and a touch panel 57 configuring a touch panel display 55; a printer 58 that prints out various information; and a communication interface 59 that performs a communication interface operation.

Here, the touch panel display 55, the printer 58, and the communication interface 59 are connected to a bus 61 via an input and output I/O 60.

The bus 61 is connected to the MPU 51, the ROM 52, the RAM 53, and the external storage unit 54.

Next, an operation of the embodiment will be described.

Before the co-injection, the electronic medical record containing prescription data of medicines is created by a doctor using the information processing terminal device 12 and is registered in the electronic medical record server 11. The prescription data includes information for specifying medicines to be administered and information relating to the required number of each medicine, and an instruction number (order number) for specifying the prescription data is allocated to the prescription data. The instruction numbers are either handed over together with a medicine administering instruction to a pharmacist or a nurse who collects medicines to be administered and performs a medicine administering operation, or are printed out as symbol codes such as barcodes in the medicine administering instruction.

Meanwhile, once an operator such as a nurse, who collects medicines to be administered and practically performs a medicine administering operation, receives an instruction number, the operator collects the medicines to be administered.

First, an outline of a process of collecting medicines to be administered will be described.

The display 36 of the touch panel display 35 of the administering support terminal device 14 displays a login screen in an initial state. Accordingly, the operator of the administering support terminal device 14 logs in to the device through a predetermined procedure (for example, by making the device read an ID card, by inputting an ID number, or the like) for authenticating the operator.

When the operator is authenticated through the login process, the MPU 31 of the administering support terminal device 14 displays a screen, which prompts the operator to read the barcodes of a medicine administering instruction that are separately issued, to a display screen of the display 36. Thus, the operator passes the barcodes of the medicine administering instruction over the scanner to make the scanner read the barcodes of the medicine administering instruction.

Accordingly, when the operator makes the scanner 38 read the barcodes of the medicine administering instruction, the MPU 31 of the administering support terminal device 14 inquires the instruction details of the electronic medical record server 11 or the pharmacy server 15 via the communication interface 40 and the communication network 17 and displays an instruction detail display screen containing a list of medicines to be collected based on the obtained data of the list of medicines to be administered.

Accordingly, the operator collects the medicines based on the list of medicines, which is on the instruction detail display screen, to be collected, and performs inspection during the collection of the medicines by making the scanner 38 read the barcodes attached to the medicines again.

Then, when all the barcodes of the medicines included in the list of medicines to be collected are read, the operation of the inspection of (collecting) the medicine finishes.

Next, a process during the medicine administering operation will be described.

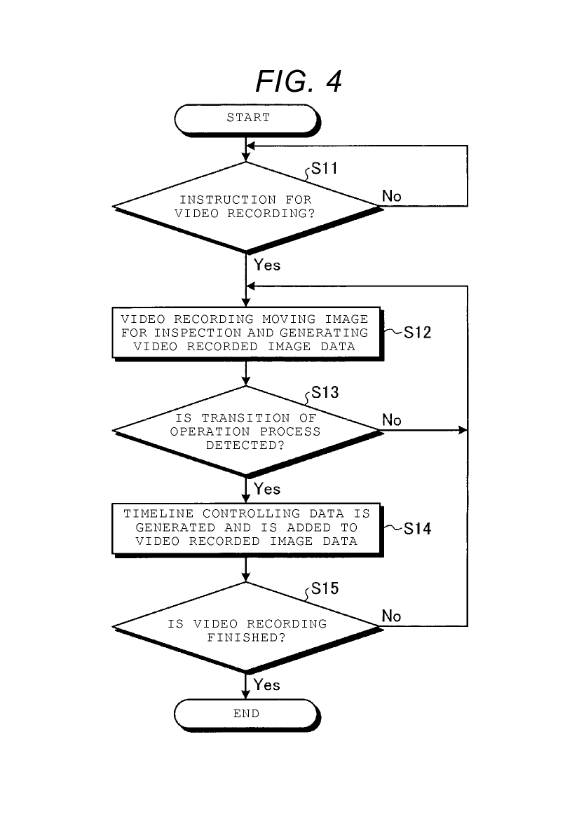

FIG. 4 is a processing flow chart of the administering support terminal device during the medicine administering operation.

In the present embodiment, in order to inspect a separate medicine administering operation, the medicine administering operation is video recorded using the camera 41.

First, the MPU 31 of the administering support terminal device 14 determines whether or not the operator instructs the video recording of the operation by manipulating the touch panel 37 (Step S11). In this case, a configuration is possible of either directly instructing the video recording or assuming that the video recording is (indirectly) instructed through the instruction for starting the medicine administering operation.

When no instruction for the video recording is made through the determination in Step S11 (Step S11; No), the MPU 31 of the administering support terminal device 14 enters a standby state.

When the instruction for the video recording is made through the determination in Step S11 (Step S11; Yes), the MPU 31 generates video recorded image data by controlling the camera 41 via the input and output I/O 45 and by making the camera video record the moving image in a medicine administering operation position which is previously set (Step S12).

Accordingly, the display 36 of the touch panel display 35 displays the moving image during video recording.

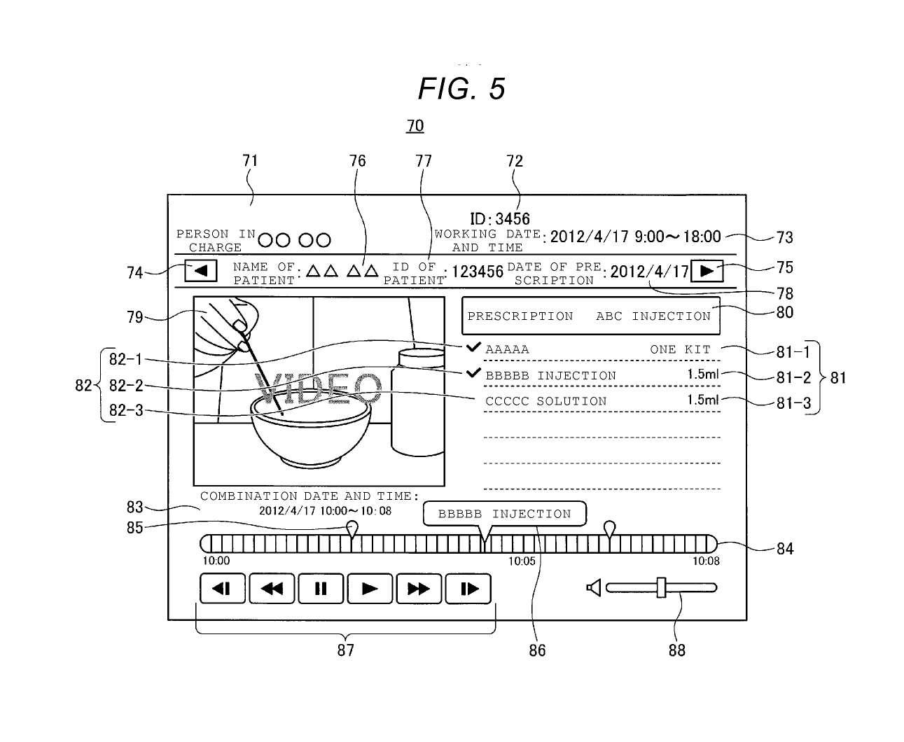

FIG. 5 is a diagram illustrating a screen of video recording and displaying the moving image for inspection.

The screen of video recording and displaying the moving image for inspection 70 includes a name-of-person-in-charge display area 71 for displaying a name of a person in charge of the medicine administering operation; an ID-of-person-in-charge display area 72 displaying an ID of a person in charge of the medicine administering operation, which specifies the person in charge of the medicine administering operation; a working-date-and-time display area 73 for displaying the working date and time for the person in charge of the medicine administering operation; a first display detail change button 74 for displaying a screen of a medicine administering operation having an oldest instruction number when there are a plurality of medicine administering operations corresponding to the inspection; a second display detail change button 75 for displaying a screen of a medicine administering operation having a newest instruction number when there are a plurality of medicine administering operations corresponding to the inspection; a name-of-patient display area 76 for displaying a name of a patient for the prescription of medicines which are subject to the medicine administering operation; a patient ID display area 77 for displaying an ID of a patient for specifying a patient for the prescription of medicines which are subject to the medicine administering operation; a prescription date display area 78 for displaying the date of the prescription of medicines which are subject to the medicine administering operation; a moving image display area 79 displaying a moving (video) image during the video recording or a moving (video) image during the reproducing; a prescribed-medicine name display area 80 for displaying the name of prescribed medicines which are subject to the medicine administering operation; a display manipulation area of a list of medicines subject to medicine administering 81 that includes a plurality of display manipulation areas of a list of medicines subject to medicine administering 81-1 to 81-3 for displaying names and prescribed amounts of medicines to be administered per medicine; a checkmark display area 82 including a plurality of checkmark display areas 82-1 to 82-3 for displaying checkmarks corresponding to medicines to which medicine administering of the medicines is already performed; a combination-date-and-time display area 83 for displaying the combination date and time at which the medicine administering operation is performed; a timeline display area 84 for displaying elapsed time of a moving-image record during the video recording or elapsed time of a moving-image reproduction during the reproducing, associated with contents of scene; transition-timing display controls 85 and 86 displayed at a transition timing at which a process of a medicine administering operation is shifted to other process, together with the timeline display area 84; a reproduction manipulation area 87 to which a plurality of buttons for performing control during the reproduction of a moving image are provided; and a volume adjustment display manipulation area 88 for adjusting a reproduction volume.

The MPU 31 determines whether the plurality of transitions of the operation processes configuring the medicine administering operation are detected in parallel with the video recording of the moving image of the medicine administering operation position and the generation of the video recorded image data (Step S13).

Here, the detection of the plurality of transitions of the operation processes configuring the medicine administering operation will be described in detail.

In the medicine administering operation, an operation to add one kind of or a plurality of kinds of medicines to a combination and preparation container, and a combining operation are repeated.

In the present embodiment, when the plurality of transitions of the operation processes configuring the medicine administering operation are detected, the timing of adding medicines to the combination and preparation container is set to be detected.

Examples of the detection of the timing of adding medicines to the combination and preparation container include the following.

(1) A timing at which medicines are added by the operator and any of the display manipulation areas of a list of medicines subject to medicine administering 81-1 to 81-3 corresponding to the added medicine(s) among the plurality of display manipulation areas of a list of medicines subject to medicine administering 81-1 to 81-3 is touched by the operator.

(2) A timing at which barcodes of the medicines to be added are read via the scanner 38.

(3) A timing at which the reading of the barcodes or names of the medicines to be added is finished when performing an image recognition process of the moving image video recorded by the camera 41.

(4) A timing at which the adding of the medicines is confirmed by recognizing the operator voice which is input from the microphone 42 by the voice recognition unit 43.

(5) A timing at which a weight change in the combination and preparation container is detected by the measuring unit 44 and a weight change corresponding to medicines to be added is detected.

When the plurality of transitions of the operation processes configuring the medicine administering operation are not detected in the determination in Step S13 (Step S13; No), the process returns to Step S12 again to perform the following process.

When the plurality of transitions of the operation processes configuring the medicine administering operation are detected in the determination in Step S13 (Step S13; Yes), the MPU 31 that detected the timing of adding medicines to the combination and preparation container generates timeline controlling data at least in data relating to a time at which medicines are added, among the times at which the medicines are added (an absolute time or a relative time as an elapsed time from the video recording start time), the name of the added medicines, and the added amount of the medicines, and incorporates the timeline controlling data into the video recorded image data (Step S14).

In this case, the timeline controlling data may be directly incorporated into the video recorded image data, or indirectly incorporated into the video recorded image data as metadata of the video recorded image data.

The timeline controlling data is used for displaying transition-timing display controls 85 and 86 in the timeline display area 84.

The transition-timing display controls 85 and 86 are set such that, during the video recording of the moving image, the corresponding time, added medicine name, or the like is displayed by selection.

The timeline controlling data corresponding to the transition-timing display control 86 includes names of medicines corresponding to the transition timing as text data. In this case, as shown in FIG. 5, text indicating the names of the medicines is shown in the transition-timing display control 86. The text may be shown at all times or may be shown only when the operator selects or manipulates the transition-timing display control such as the transition-timing display control 85 so that the display can be simplified.

Subsequently, the MPU 51 determines whether or not the operator instructs finishing the video recording (Step S15).

When the operator does not instruct finishing the video recording in the determination in Step S15 (Step S15; No), the process moves to Step S12 to repeat the same process as follows.

When the operator instructs to finish the video recording in the determination in Step S15 (Step S15; Yes), the camera 41 finishes the video recording, the generated video recorded image data is stored in the external storage unit 34 as a video recorded image file and is sent to the pharmacy server 15 or the information processing terminal device 16 for an inspector via the communication network 17.

Accordingly, in the pharmacy server 15 or the information processing terminal device 16 for an inspector, the video recorded image file is stored in the external storage unit such as an HDD.

Next, a process while inspecting a medicine administering operation will be described.

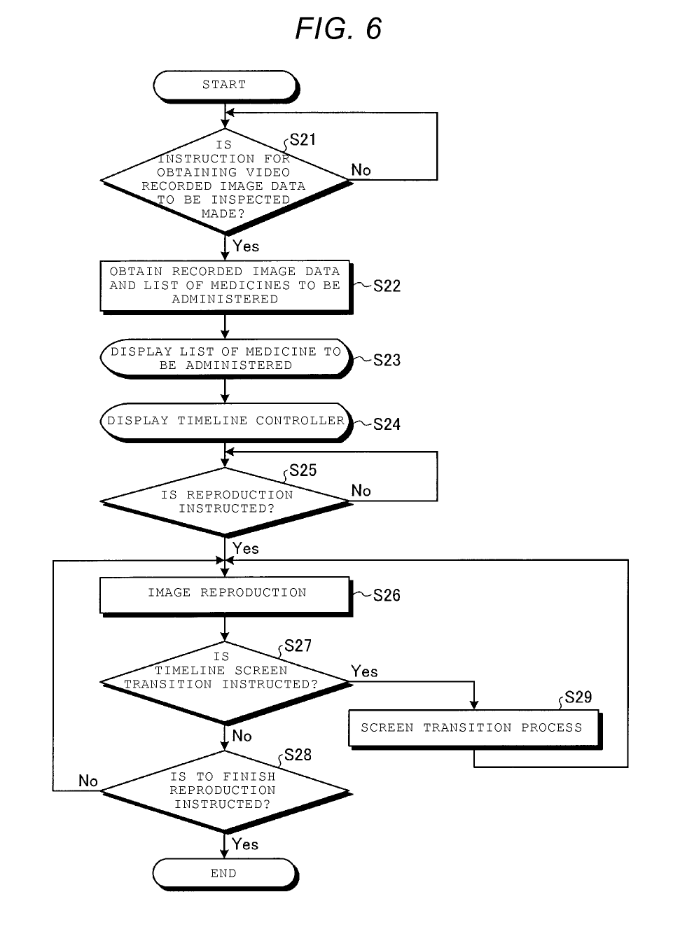

FIG. 6 is a processing flow chart of the information processing terminal device for an inspector while inspecting the medicine administering operation.

In the following description, the video recorded image file is stored in the pharmacy server 15 and the process will be described with reference to FIG. 5 again.

First, the MPU 51 of the information processing terminal device 16 for an inspector determines whether or not an instruction for inspection accompanied by an instruction number is input for specifying the prescription data and an instruction for obtaining the video recorded image data to be inspected is made (Step S21).

When no instruction for obtaining the video recorded image data to be inspected is made through the determination in Step S21 (Step S21; No), the MPU 51 of the information processing terminal device 16 enters a standby state.

When the instruction for obtaining the video recorded image data to be inspected is made through the determination in Step S21 (Step S21; Yes), the MPU 51 of the information processing terminal device 16 inquires the pharmacy server 15 through the communication network 17 for the video recorded image data corresponding to the video recorded image file and the list of medicines to be administered (Step S22).

Then, the MPU 51 of the information processing terminal device 16 displays a screen for video recording and displaying the moving image for inspection 70 as shown in FIG. 5.

That is, the MPU 51 of the information processing terminal device 16 displays a name of a person in charge of the medicine administering operation in the name-of-person-in-charge display area 71; displays an ID of a person in charge of the medicine administering operation that specifies the person in charge of the medicine administering operation in the ID-of-person-in-charge display area 72; and displays the working date and time of the person in charge of the medicine administering operation in the working-date-and-time display area 73.

Furthermore, the MPU 51 of the information processing terminal device 16 displays a name of a patient for the prescription of medicines in the name-of-patient display area 76, displays an ID of a patient for specifying a patient in the patient ID display area 77, and displays the date of the prescription of medicines which are subject to the medicine administering operation in the prescription date display area 78.

Then, the MPU 51 of the information processing terminal device 16 displays a list of medicines to be administered in the display manipulation area of a list of medicines subject to medicine administering 81 (Step S23).

Next, the MPU 51 of the information processing terminal device 16 displays the timeline in the timeline display area 84 and displays transition-timing display controls 85 and 86 as timeline controllers (Step S24).

In this state, the MPU 51 of the information processing terminal device 16 determines whether or not the operator manipulates the play button in the reproduction manipulation area 87 to instruct the reproduction (Step S25).

When the determination of Step S25 is that no instruction for the reproduction is yet made (Step S25; No), the MPU 51 of the information processing terminal device 16 enters a standby state.

When the determination of Step S25 is that instruction for the reproduction is made (Step S25; Yes), the MPU 51 of the information processing terminal device 16 starts the reproduction of a moving image and the moving (video) image is displayed in the moving image display area 79 (Step S26).

The MPU 51 of the information processing terminal device 16 determines whether or not the operator instructs a timeline screen transition by manipulating the transition-timing display controls 85 and 86 in parallel with the reproduction of the image (Step S27).

When the determination in Step S27 is that no instruction of the timeline screen transition is made (Step S27; No), the MPU 51 of the information processing terminal device 16 determines whether or not the operator instructs finishing the reproduction by manipulating the stop button in the reproduction manipulation area (Step S28).

When the determination of Step S28 is that no instruction to finish the reproduction is yet made (Step S28; No), the MPU 51 of the information processing terminal device 16 continues to reproduce the image by returning the process to Step S26.

When the determination in Step S28 is that an instruction to finish the reproduction is made (Step S28; Yes), the MPU 51 of the information processing terminal device 16 finishes the image reproduction process.

Meanwhile, when the determination in Step S27 is that the operator instructs the timeline screen transition by manipulating the transition-timing display controls 85 and 86 (Step 27; Yes), the MPU 51 of the information processing terminal device 16 shift the screen to a reproduction screen corresponding to a time (for example, a timing of adding the medicines) corresponding to the manipulated transition-timing display controls 85 and 86.

Specifically, when the transition-timing display control 86 is manipulated, in a case of FIG. 5 as an example, since a graduation of the timeline display area 84 corresponds to about 10 seconds, the time of adding the medicine “99mTcO4” is a time around 10:04:25 (reference time) which is 35 seconds before (3.5 graduations) 10:05:00, and the transition-timing display control 86 is operated to perform reproduction from 10:04:20 which is a predetermined time before (for example, 5 seconds before) the reference time in order to prevent the overlooking of an important event.

As described above, according to the present embodiment, when the medicines to be administered are inspected using the moving image, it is possible to easily grasp the points to be inspected by taking special care to perform the inspection process. Therefore, it is possible to perform many inspections even with a few persons in charge of the inspection by shortening the time for the inspection.

In addition, since it is possible to display the information (names of the medicines, the added amounts, or the like) of the medicines added during the medicine administering operation as text when displaying the timeline, the operator may easily grasp the situation and surely perform the inspection.

In the above description, the administering support terminal device 14 configured as the apparatus for managing medicine combination and preparation is configured as a stationary information processing device (computer). However, the configuration is not limited to this, and it is possible to include a tablet type information processing device, a notebook type information processing device, and a portable information processing device such as a smart phone.

In this case, it is possible to configure use of a printer to which a wireless LAN or the like is connected.

In the above description, when specifying the medicines to be administered, for example, a barcode called a GS1 data bar is used as a code which is read by the scanner 38 or the camera 41. However, the configuration is not limited to the barcode, and RFID may be used.

The case where the administering support terminal device 14 configured as the apparatus for managing medicine combination and preparation is used in the hospital is exemplified in the above description. However, the configuration is not limited to this case, and may also be applied to any field as long as it is necessary to perform the combination and preparation of medicines such as a dispensing pharmacy, a study room, and a laboratory.

The control program which is executed in the apparatus for managing medicine combination and preparation of the present embodiment is provided by being recorded in a recording medium, which may be read by a computer, such as a CD-ROM, a flexible disk (FD), a CD-R, and a digital versatile disc (DVD), as a type of file which may be installed or executed.

In addition, the control program which is executed in the apparatus for managing medicine combination and preparation of the present embodiment may be configured to be provided by making the control program be stored in a computer connected to a network such as the Internet and be downloaded via the network. In addition, the control program which is executed in the apparatus for managing medicine combination and preparation of the present embodiment may be configured to be provided or distributed via a network such as the Internet.

In addition, the control program which is executed in the apparatus for managing medicine combination and preparation of the present embodiment may be configured to be provided by being incorporated in the ROM or the like in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An apparatus for managing a medicine administering process to enable inspection of the medicine administering process, the apparatus comprising:
a video recording unit configured to generate video recorded image data by video recording the medicine administering process; and
a data addition unit configured to add controlling data that enables the recorded video of the medicine administering process to be displayed with display elements that depict transition events of the medicine administering process.

2. The apparatus according to claim 1, wherein
the display elements include a timeline of the medicine administering process and a control element on the timeline that can be moved along the timeline to display the recorded video at a particular point in time corresponding to the position of the control element on the timeline.

3. The apparatus according to claim 2, wherein the display elements further include identification of the medicine to be administered, a patient to which the medicine is to be administered, a doctor who prescribed the medicine to be administered, and a person who is administering the medicine to the patient.

4. The apparatus according to claim 2, wherein the display elements further include additional control elements for playing the video, stopping or pausing the video, and adjusting the volume of the audio that is reproduced with the video.

5. The apparatus according to claim 1, further comprising:
a timing specifying section configured to detect timing of transition events.

6. The apparatus according to claim 5, wherein
the timing specifying section detects as a transition event at least one of a timing of the weight of medicines changing during the medicine administering process, a timing at which a code symbol of medicines to be administered is read, a timing at which a selection operation is performed on a displayed list of medicines, and a timing at which medicines to be administered are detected by voice recognition.

7. The apparatus according to claim 1, further comprising
a communication unit by which the recorded video having the controlling data added thereto is transmitted to an inspection terminal through a communication network.

8. The apparatus according to claim 1, wherein the transition events include the weight of medicines changing during the medicine administering process, a timing at which a code symbol of medicines to be administered is read, a timing at which a selection operation is performed on a displayed list of medicines, and a timing at which medicines to be administered are detected by voice recognition

9. A method of recording a medicine administering process to enable inspection of the medicine administering process, the method comprising:
video recording the medicine administering process; and
adding controlling data that enables the recorded video of the medicine administering process to be displayed with display elements that depict transition events of the medicine administering process.

10. The method according to claim 9, wherein
the display elements include a timeline of the medicine administering process and a control element on the timeline that can be moved along the timeline to display the recorded video at a particular point in time corresponding to the position of the control element on the timeline.

11. The method according to claim 10, wherein the display elements further include identification of the medicine to be administered, a patient to which the medicine is to be administered, a doctor who prescribed the medicine to be administered, and a person who is administering the medicine to the patient.

12. The method according to claim 10, wherein the display elements further include additional control elements for playing the video, stopping or pausing the video, and adjusting the volume of the audio that is reproduced with the video.

13. The method according to claim 9, further comprising:
detecting timing of transition events, which include the weight of medicines changing during the medicine administering process, a timing at which a code symbol of medicines to be administered is read, a timing at which a selection operation is performed on a displayed list of medicines, and a timing at which medicines to be administered are detected by voice recognition.

14. The method according to claim 13, further comprising:
transmitting the recorded video having the controlling data added thereto an inspection terminal through a communication network.

15. A control program for recording a medicine administering process to enable inspection of the medicine administering process, the control program stored in a non-transitory computer readable medium an executed by a computer to carry out the steps of:
video recording the medicine administering process; and
adding controlling data that enables the recorded video of the medicine administering process to be displayed with display elements that depict transition events of the medicine administering process.

16. The control program according to claim 15, wherein
the display elements include a timeline of the medicine administering process and a control element on the timeline that can be moved along the timeline to display the recorded video at a particular point in time corresponding to the position of the control element on the timeline.

17. The control program according to claim 16, wherein the display elements further include identification of the medicine to be administered, a patient to which the medicine is to be administered, a doctor who prescribed the medicine to be administered, and a person who is administering the medicine to the patient.

18. The method according to claim 16, wherein the display elements further include additional control elements for playing the video, stopping or pausing the video, and adjusting the volume of the audio that is reproduced with the video.

19. The control program according to claim 15, wherein the steps further comprise:
detecting timing of transition events, which include the weight of medicines changing during the medicine administering process, a timing at which a code symbol of medicines to be administered is read, a timing at which a selection operation is performed on a displayed list of medicines, and a timing at which medicines to be administered are detected by voice recognition.

20. The control program according to claim 19, wherein the steps further comprise:
transmitting the recorded video having the controlling data added thereto an inspection terminal through a communication network.
